(19) United States
(12) Patent Application Publication
(10) Pub. No.: US 2006/0175740 A1
(43) Pub. Date: Aug. 10, 2006

(54) Method for manufacturing a microwave substrate

(75) Inventor: Bar-Long Denq, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Compal Electronics, Inc.

(21) Appl. No.: 11/201,534

(22) Filed: Aug. 11, 2005

(30) Foreign Application Priority Data
Feb. 5, 2005 (TW) 94104055

(51) Int. Cl. C04B 35/624

(52) U.S. Cl. 264/621; 264/624

(57) ABSTRACT

A method for manufacturing a microwave substrate is disclosed. In particular, the method of the present invention uses the sol-gel process to form a ceramic-polymer composite microwave substrate. First, an alkoxy silane, water, a catalyst, an alcohol, and a polymer are mixed to form a sol-gel mixture. Next, the water and alcohol in the sol-gel mixture are removed by exerting a pressure. Finally, the sol-gel mixture is sintered to form a microwave substrate.

### RELATED APPLICATIONS

The present application is based on, and claims priority from, Taiwan Application Serial Number 94104055, filed Feb. 5, 2005, the disclosure of which is hereby incorporated by reference herein in its entirety.

### FIELD OF THE INVENTION

The present invention relates to a method for manufacturing a microwave substrate, and more particularly, to a method for manufacturing a microwave substrate by using a sol-gel process.

### BACKGROUND OF THE INVENTION

Currently, microwave substrates used in the industry can be classified into polytetrafluoroethylene (PTFE) substrates, polyester (PET) substrates, and glass expoxy (FR4) substrates according to the material types, wherein the PTFE substrates cover the broadest frequency spectrum. A conventional PTFE substrate is made of the PTFE and fillers (such as ceramic powders or glass fibers) undergoing the steps of special mixing and high-temperature sintering. Currently, among the methods for manufacturing PTFE composites, the one for forming PTFE-ceramic composite material is the most matured.

The conventional method for manufacturing a PTFE-ceramic composite substrate is to react ceramic powders which act as fillers with a couplant first, thereby performing a surface treatment to the ceramic powders. The purpose of the surface treatment is to make the ceramic powders tightly combined with the PTFE. Thereafter, the treated ceramic powders are mixed with the PTFE, and, simultaneously, a proper lubricant is added therein. Subsequently, the PTFE and ceramic powders are mixed and ground for quite a long time under high temperature, and then the mixture of the PTFE and ceramic powders is compressed by extreme high pressure so as to form an isotropic PTFE-ceramic composite. Finally, the PTFE-ceramic composite is sintered under high temperature to form a PTFE-ceramic composite substrate, which is subsequently laminated with a copper foil to form a microwave substrate.

However, the conventional manufacturing method has some drawbacks. Firstly, the ceramic powders have to undergo complicated surface treatments for facilitating mixing with PTFE powders or emulsions. Secondly, the plastic-processing equipment used for mixing and grinding the PTFE and ceramic powders under high temperature is very expensive. Thirdly, as the weight ratio of the ceramic powders which act as fillers to the PTFE increases or when the size of ceramic powders is too small, it is difficult to mix the ceramic powders with the PTFE uniformly. For example, when the weight ratio of the ceramic powders used is higher than 60%, the volume fraction of the filler phase (ceramic powders) is larger than that of the continuous phase (PTFE) in the process of mixing, thus causing the mixing operation to lose the dispersion efficacy entirely.

Hence, it is needed to provide a method for manufacturing a microwave substrate for replacing the conventional method of high-temperature mixing and effectively mixing fillers with polymers so as to save equipment cost and simplify the manufacturing process.

### SUMMARY OF THE INVENTION

One aspect of the present invention is to provide a method for manufacturing a microwave substrate to replace the complicated process steps in the conventional method, thereby saving the expensive equipment cost, and obtaining the microwave substrate of which the quality is close to or better than the quality of the microwave substrate made by the conventional method.

The other aspect of the present invention is to provide a method for manufacturing a microwave substrate, so that polymers can uniformly mixed with ceramic powders even under the high percentage of ceramic powders.

According to the aforementioned aspects, the present invention provides a method for manufacturing a microwave substrate. In the manufacturing method of the present invention, an alkoxy silane, water, a catalyst, an alcohol, and a polymer are mixed to perform a sol-gel reaction, which makes the alkoxy silane undergo a hydrolysis and condensation reaction so as to form a sol-gel mixture. Next, the water and alcohol in the sol-gel mixture are removed via high pressure or vacuum state so as to compact the sol-gel mixture tightly into a predetermined shape. After that, the sol-gel mixture is sintered under high temperature, and then the sol-gel formed from the alkoxy silane in the sol-gel mixture becomes tiny ceramic particles uniformly dispersed in the polymer. Finally, a microwave substrate can thus be formed.

In the method for manufacturing the microwave substrate of the present invention, the pH value of the sol-gel mixture is not limited to any special range, and the pH value is preferably about between 2 and 5. The molar ratio of water to the alkoxy silane is preferably about between 1 and 1.3. The species of the alkoxy silane used in the present invention do not have special limitations. Preferably, the alkoxy silane is tetraethylorthosilicate (or called tetraethoxysilane, TEOS) or tetramethylorthosilicate (or called tetramethoxysilane, TMOS). More preferably, the alkoxy silane is TEOS. Preferably, the catalyst used in the present invention is an acid catalyst. More preferably, the catalyst is nitric acid, phosphoric acid, or acetic acid. The alcohol used in the present invention can be any conventional alcohol, and preferably, the alcohol is methanol, ethanol, propyl alcohol or isopropanol. The polymer used in the present invention is preferably PTFE used in the types of emulsions or powders. The pressure used for removing the water and alcohol in the sol-gel mixture can be high pressure or vacuum pressure, and is preferably about between 20 Mpa and 150 Mpa or between the pressure less than 1 atmosphere and that at a vacuum state, and more preferably about between 20 Mpa and 150 Mpa. The temperature of sintering the sol-gel mixture preferably is about between 250° C. and 450° C.

One advantage of the present invention is to mix polymers with ceramic powders by using a chemical method in order to achieve the objective of dispersing ceramic powders in the polymers uniformly.

Another advantage of the present invention is to mix polymers with ceramic powders by a chemical method instead of the complicated surface treatment and mixing steps performed on the ceramic powders in the conventional method, and thereby to save time and expensive equipment cost.

Another advantage of the present invention is that the ceramic powders forming the microwave substrate have relatively small particle size and are uniformly dispersed in the polymer. Also, when the proportion of the ceramic powders used in the microwave substrate increases, the ceramic powders still can be dispersed in the polymer uniformly, thus solving the problem of the conventional method that the ceramic powders can not be uniformly dispersed in the polymer.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a schematic flow diagram showing a first preferred embodiment of the present invention;

FIG. 1B is a schematic flow diagram showing a second preferred embodiment of the present invention;

FIG. 2A is a cross-sectional view of the microwave substrate manufactured by the conventional method; and

FIG. 2B is a cross-sectional view of the microwave substrate manufactured by the method of the present invention.

### DETAILED DESCRIPTION OF THE PREFERRED EMBODIMENT

A method for manufacturing a microwave substrate is disclosed in the present invention. The present invention uses a chemical method to replace the conventional method having complicated surface treatment and mixing process for mixing ceramic powders with polymers to manufacture a microwave substrate.

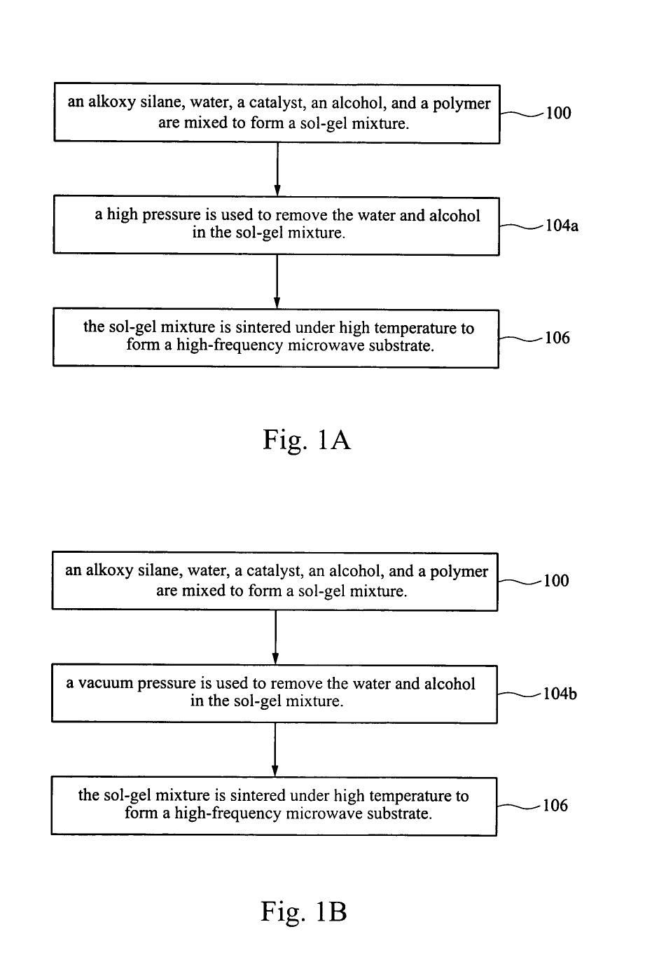

FIG. 1A is a schematic flow diagram showing a first preferred embodiment of the present invention. In step 100, an alkoxy silane, water, a catalyst, an alcohol, and a polymer, such as PTFE emulsions or powders, are mixed to form a sol-gel mixture. The molar ratio of the water to the alkoxy silane is about 1 to 1.3, and the pH value of the mixture is modified to between 2 and 5. A catalysis reaction is performed at a temperature between 20° C. to 70° C. so as to make the alkoxy silane undergo a sol-gel reaction and form a sol-gel mixture.

Subsequently, in step 104a, a pressure about 20 Mpa to 150 Mpa or higher is used to compress the sol-gel mixture for removing the water and alcohol from the sol-gel mixture and tightly compacting the sol-gel mixture into a predetermined shape. Next, in step 106, the sol-gel mixture is sintered under the temperature between 250° C. to 450° C. to form a composite substrate combining ceramic powders with polymers. A metal foil, such as a copper foil, is subsequently adhered to the ceramic-polymer composite substrate so as to form a microwave substrate.

In the aforementioned steps, the alkoxy silane used can be either TEOS or TMOS, and the acid used as a catalyst can be phosphoric acid, nitric acid, or acetic acid, and the alcohol used can be methanol, ethanol, propyl alcohol or isopropanol. Besides, referring to FIG. 1B, the step 104a of removing the water and alcohol via high pressure also can be replaced by the step 104b in which a vacuum state of the pressure less than 1 atmosphere is used to remove the water and alcohol out of the sol-gel mixture.

Hereinafter, according to the aforementioned method of the present invention, the following preferred embodiments are provided and compared with the conventional method to explain the method of the present invention.

### Embodiment 1

A fixed amount of TEOS is dissolved in the ethanol of appropriate amount. A nitric acid used as a catalyst is added to adjust the pH value of the solution to 2, thereby catalyzing a sol-gel reaction. The TEOS in the solution is reacted at room temperature to form a sol-gel solution. Thereafter, the PTFE emulsion and deionized water are added into the sol-gel solution and mixed uniformly to form a sol-gel mixture. Next, the sol-gel mixture is heated to 70° C. and reacted continuously at 70° C. for 6 hours. The ratio of water to TEOS is 1.1 in the aforementioned mixing process.

The sol-gel mixture is then stirred in a high speed milling machine, and then screened through a 150-mesh screen, which has a mesh diameter of 104 μm so as to ensure that there is no non-uniformly mixed or un-reacted mass particles existing in the sol-gel mixture. Thereafter, the sol-gel mixture is compressed under 100 Mp pressure to remove the water and alcohol therein, and simultaneously to compact the sol-gel mixture tightly. For example, the sol-gel mixture can be placed in a container of a piston, which provides a high pressure to compress the sol-gel mixture for removing the water and alcohol therein.

Thereafter, the shaped and dried sol-gel mixture is placed in nitrogen atmosphere, and then the temperature is raised to 340° C. at a slow heating rate for performing a sintering step, thereby to obtain a ceramic-PTFE microwave substrate of the first preferred embodiment of the present invention. For example, the temperature is increased to 340° C. at a heating rate of 5° C./min and maintained at 340° C. for 3 hours to sinter the sol-gel mixture. Then, the temperature is cooled to the room temperature at a slow rate.

### Embodiment 2

Embodiment 2 is carried out with the same steps of embodiment 1, except that the pressure used for removing water and alcohol is decreased to 50 Mpa. The temperature for sintering the sol-gel mixture is kept at 340° C. Consequently, the ceramic-PTFE microwave substrate of the second preferred embodiment of the present invention is obtained.

### Embodiment 3

Embodiment 3 is carried out with the same steps of embodiment 1, except that the temperature for sintering the sol-gel mixture is increased to 360° C. The ceramic-PTFE microwave substrate of the third preferred embodiment of the present invention is thus obtained.

### Embodiment 4

Embodiment 4 is carried out with the same steps of embodiment 1, except that the pressure used for removing water and alcohol is decreased to 50 Mpa and the temperature for sintering the sol-gel mixture is increased to 360° C. The ceramic-PTFE microwave substrate of the forth preferred embodiment of the present invention is thus obtained.

### COMPARATIVE EXAMPLE 1

Phenyltrimethoxysilane is mixed in isopropanol and deionized water, and is hydrolyzed at room temperature for 6 hours. Silica with a particle size of about 0.25 μm is immersed in the hydrolyzed phenyltrimethoxysilane solution to react at 120° C. for about 10 minutes. Thereafter, the silica is dried in vacuum at 105° C. for 24 hours. The aforementioned silica is then pulverized by a high speed milling machine and screened with a 150-mesh screen, of which the mesh diameter is 104 cm so as to ensure the silica dispersed uniformly. Finally, the treated ceramic powders, PTFE emulsions, and N-(β-aminoethyl)-γ-aminotrimethoxypropylesterl are sintered under the conditions of 340° C. and 100 Mpa according to the method disclosed in U.S. Pat. No. 4,331,580. The ceramic-PTFE microwave substrate of the comparative example 1 is thus prepared.

### COMPARATIVE EXAMPLE 2

Comparative example 2 is carried out with the same steps of comparative example 1, except that the pressure is decreased to 50 Mpa. The ceramic-PTFE microwave substrate of the second comparative example 2 is thus obtained.

### COMPARATIVE EXAMPLE 3

Comparative example 3 is carried out with the same steps of comparative example 1, except that the temperature is increased to 360° C. The ceramic-PTFE microwave substrate of the third comparative example is thus obtained.

### COMPARATIVE EXAMPLE 4

Comparative example 4 is carried out with the same steps of comparative example 1, except that the pressure is decreased to 50 Mpa and the temperature is increased to 360° C. The ceramic-PTFE microwave substrate of the forth comparative example is thus obtained.

Comparsion of the Dielectric Property

The dielectric constant of the microwave substrates prepared in the embodiments 1 to 4 and the comparative examples 1 to 4 are measured respectively. Referring to Table 1, it shows that the dielectric constant of the microwave substrates prepared in various temperatures and pressures by the present invention are quite close to those of the microwave substrates prepared by the conventional method. Besides, if both the pressure for removing water and alcohol and the temperature for sintering increase, the dielectric constant of the microwave substrate according to the present invention will be better than that of the microwave substrate made according to the conventional method. For example, the dielectric constant value of the present invention can reach to 2.3.

TABLE 1

| | | Dielectric constant | |
|---|---|---|---|
| | | Conventional | Present |
| Temperature(° C.) | Pressure(Mpa) | method | invention |
| 340 | 50 | 2.45 | 2.63 |
| | 100 | 2.37 | 2.57 |
| 360 | 50 | 2.35 | 2.42 |
| | 100 | 2.33 | 2.41 |

Observation of Morphology

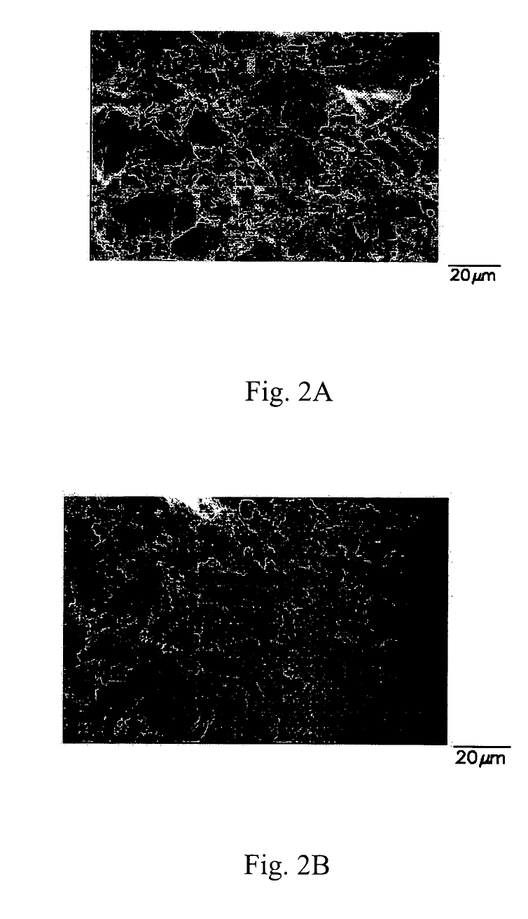

Cross-sectional views of the microwave substrates prepared in the comparative example 3 and the embodiment 3 are observed by a scanning electron microscope (SEM). With reference to FIGS. 2A-2B, FIG. 2A is the cross-sectional view of the microwave substrate prepared by the conventional method, and FIG. 2B is the cross-sectional view of the microwave substrate prepared by the present invention. Compared to the conventional method, the ceramic powders in the microwave substrates shown in FIG. 2B have smaller size, and are uniformly dispersed in the PTFE. The size of the ceramic powders in FIG. 2A is determined by the contents of ceramic powders used. When the weight ratio of ceramic powders is more than 60%, the ceramic powders cannot be dispersed in the PTFE uniformly. If the proportion of the ceramic powders is further increased, the conventional method will loss the capability of dispersing ceramic powders and fail to obtain a uniform microwave substrate, so that the dielectric constants of the different block areas located on the microwave substrate will be different. However, the ceramic-PTFE microwave substrate prepared by the method of the present invention do not has the aforementioned shortcomings.

Besides, it should be particularly noted that the pressure for removing the water and alcohol in the sol-gel mixture can be a high pressure or vacuum pressure. The high pressure ranges between 20 Mpa and 150 Mpa, and the vacuum pressure is a vacuum state of the pressure less than 1 atmosphere.

It can be known from the foregoing results of the embodiment 1 to 4 and the comparative examples 1 to 4 that the present invention uses a simple chemical method to replace the complicated mixing process and time-consuming surface treatment performed on ceramic powders in the conventional method. Also, the cost of expensive equipments used for mixing and grinding can be saved and the manufacturing time can be shortened. In addition, the quality of the microwave substrates prepared by the present invention is close to or even superior to that of the microwave substrates made by the conventional method.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for manufacturing a microwave substrate, said method comprising:
mixing an alkoxy silane, water, a catalyst, an alcohol, and a polymer to form a sol-gel mixture;
exerting a pressure to remove said water and said alcohol out of said sol-gel mixture; and
sintering said sol-gel mixture to form a microwave substrate.

2. The method of claim 1, wherein the pH of said sol-gel mixture is substantially between 2 and 5.

3. The method of claim 1, wherein said alkoxy silane is tetraethylorthosilicate (TEOS) or tetramethylorthosilicate (TMOS).

4. The method of claim 1, wherein the molar ratio of said water to said alkoxy silane is substantially between 1 and 1.3.

5. The method of claim 1, wherein said catalyst is an acid catalyst.

6. The method of claim 5, wherein said acid catalyst is selected from the group consisting of phosphoric acid, nitric acid and acetic acid.

7. The method of claim 1, wherein said alcohol is selected from the group consisting of methanol, ethanol, propyl alcohol and isopropanol.

8. The method of claim 1, wherein said polymer comprises polytetrafluoroethylene (PTFE).

9. The method of claim 1, wherein said pressure is substantially between 20 Mpa and 150 Mpa.

10. The method of claim 1, wherein said pressure is the vacuum pressure less than 1 atmosphere.

11. The method of claim 1, wherein the temperature of said sintering step is substantially between 250° C. and 450° C.
